(19) United States
(12) Patent Application Publication
(10) Pub. No.: US 2002/0124455 A1
(43) Pub. Date: Sep. 12, 2002

(54) Fish lure with flexible horizontal tail hook

(76) Inventor: Randy Bauman, Tuscaloosa, AL (US)

Correspondence Address: LANIER FORD SHAVER & PAYNE, P O BOX 2087, HUNTSVILLE, AL, 35804, US

(21) Appl. No.: 09/803,836

(22) Filed: Mar. 12, 2001

(51) Int. Cl. A01K 85/00

(52) U.S. Cl. 43/42.44

(57) ABSTRACT

A fish lure having a hook removably attached at its tail end, said hook supported approximately horizontally, in parallel with the longitudinal axis of the body of the fish lure by a support filament. One end of the support filament is attached to the tail end of the lure, and the other end of the support filament to the hook. When thus supported, a dressed hook simulates the natural motion of a fish tail fin when the lure is pulled through water. The approximately horizontal position of the hook creates a weedless lure.

### BACKGROUND OF THE INVENTION

1. Field of the Invention

The present invention relates generally to fishing lures and, particularly, to fish lures having a flexible, horizontal tail hook.

2. Background of the Invention

Fishing lures are usually made in a form and size which simulates the natural food of the game fish to be caught. Usually, the lure is in the shape of a small fish, such as a minnow, which may have certain characteristic movements, behaviors, and appearances. Typical examples of these lures are jerk bait, top water bait, and crank bait. A crank bait fishing lure is cast into the water and a line attached to the lure is then wound or “cranked” upon a reel. The lure is, thus, drawn through the water. Usually the line is attached to the forward end or nose of the lure. The nose may also contain a member extending in front of the nose, referred to as a lip, spoon, or bill. As the lure is drawn through the water by cranking the reel, the forces acting on the lip cause the lure to dive. Many of these lures tend to float when not being cranked. Other crank baits are naturally weighted and will sink while not being cranked.

The rear or tail part of these lures usually has a treble hook which, when pulled through the water, has a twirling or circular motion. The tails of a natural fish do not have this twirling or circular motion but tend to have a side-to-side or wriggling motion. A rear treble hook of a lure may also have feathers, a rubber skirt, or other adornment which is designed to simulate the tail of a small fish. In addition, these hooks hang vertically if the lure is motionless or moving slowly, and they tend to become more easily tangled on the bottom of the body of water or on vegitation through which the lure is traveling. Prior efforts to solve these problems have been to use a two piece body for the fishing lure with a hinged tail fin portion having the hook rigidly attached to the tail fin. These hinge mechanisms detract from the natural appearance of the lure, are expensive to make, and are not durable or are too difficult to keep in operating order.

### SUMMARY OF THE INVETION

The fish lure of the present invention has a fish hook movably linked at the rear or tail portion. The hook is held approximately horizontal, extending away from the tail, by a support filament composed of flexible semi-rigid fishing line, wire, or other suitable material. One end of this support filament is attached to the tail portion of the lure and the other end is attached to the hook. Because the support filament is semi-rigid, it can hold the hook approximately horizontal, or parallel to the longitudinal axis of the lure. Because the support line is also flexible, a dressed hook can wriggle in a manner closely resembling the natural side-to-side tail action of a fish when the lure is moving through the water. When using a stop-and-go presentation, the tail hook does not drop down when the lure is not being reeled but remains approximately horizontal, thus, better simulating the natural appearance of a bait fish. The positioning of the tail also dramatically increases the “catch to strike” ratio because a large number of fish striking the lure will do so from the rear of the lure. The lure is also more weedless on account of the approximately horizontal hook.

An advantage of the present invention is a fish lure with an approximately horizontal tail hook.

Another advantage of the present invention is a fish lure that supports a tail hook approximately horizontally with flexible, semi-rigid filament or wire.

Another advantage of the present invention is a fish lure with a realistic tail that has a natural wriggle when the lure is moving through the water.

Another advantage of the present invention is a fish lure with an improved “catch to strike” ratio.

Another advantage of the present invention is a fish lure that is more weedless.

### BRIEF DESCRIPTION OF THE DRAWINGS

FIG. 1 shows a crank bait fish lure of the prior art.

FIG. 2 shows a fish lure of the present invention having an approximately horizontally oriented tail hook.

FIG. 3 is a rear perspective view of the fish lure of the present invention showing a semi-rigid flexible support filament maintaining the tail hook in a horizontal position.

### DETAILED DESCRIPTION OF THE PREFERRED EMBODIMENTS

While the following description details the preferred embodiments of the present invention, it is to be understood that the invention is not limited in its application to the details of construction and arrangement of parts illustrated in the accompanying drawings, since the invention is capable of other embodiments and of being practiced in various ways.

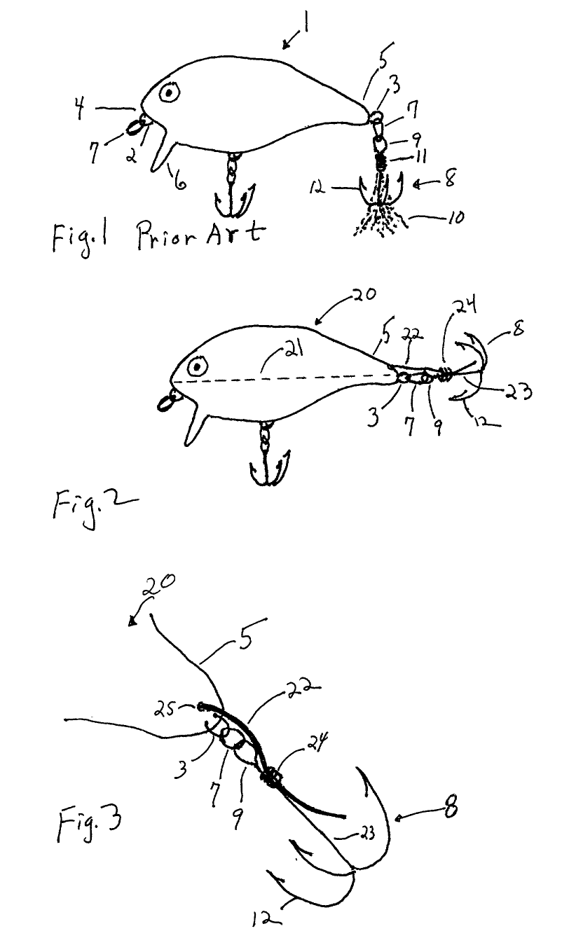

FIG. 1 shows a typical prior art crank bait fish lure having a front eyelet 2 and a rear eyelet 3 at the nose 4 and tail 5, respectively. The lure also has a lip 6, and the eyelets 2 and 3 have connecting rings 7. A treble hook 8 having three hook tips 12 is linked to the rear eyelet 3 by connecting ring 7 which is linked to hook eyelet 9. The connection of the rear eyelet 3 to hook eyelet 9 by connecting ring 7 allows hook 8 to move about the tail 5. A swivel may also be used to provide complete rotation of hook 8 around the tail. When the lure is motionless or moving slowly through water, hook 8 hangs down vertically. When the lure is moving sufficiently fast through water, the hook may have a twirling or circular motion which natural fish do not have. Hook 8 can been dressed with bristles, a rubber skirt, or feathers and the like 10, held in place by fastener 11, so that hook 8 looks like the tail fin of a fish.

FIG. 2 shows the fish lure 20 of the present invention. Although a crank bait shaped lure is depicted by way of example, the shape of the body of the lure can be varied as desired. The shapes can include, for example, top water bait, jerk bait, artificial minnow, or any other fishing lure having a tail hook. The tail hook 8 is held approximately horizontal, i.e., approximately parallel to the longitudinal axis 21 of lure 20 by a flexible semi-rigid support filament 22 which is attached to tail portion 5 and to the hook shank 23 by securing means 24. Although the preferred embodiment is depicted in FIG. 2, the support filament 22 can be attached to almost any portion of the lure 20 and hook 8. Hook 8 is preferably connected to tail 5 as described in FIG. 1, but can be attached or linked by any means by which the hook 8 is movable or rotatable.

The length of support filament 22 is not critical and needs to be only of sufficient length to attach to tail 5 and hook 8. The relationship of support filament 22 to tail 5 and hook 8 is shown more clearly in FIG. 3. The support filament 22 is flexible and semi-rigid, and can be made of, preferably, 12 lb. to 25 lb. test monofilament plastic line, wire, or thread. For example, standard 12 lb. to 25 lb. test fishing line can be used. A first end of support filament 22 can be attached to tail 5 by any suitable means, preferably by drilling a close tolerance aperture 25 in tail 5 which frictionally engages support filament 22 as support filament 22 is inserted removably into aperture 25. Support filament 22 may be inserted permanently into aperture 25 by applying glue to support filament 22 and/or aperture 25. The second opposite end of support filament 22 is attached to hook 8 by any suitable means, preferably, a small rubber band. Connecting ring 7 may be a coiled ring with open ends so that hook 8 may be inserted into or removed from connecting ring 7 by hook eyelet 9. Hook 8 can be dressed, as shown in FIG. 1, with the bristles 10 and fastener 11 forming a “hair teaser tail.”

Because support filament 22 is semi-rigid it can support hook 8 and hook shank 23 in an approximately horizontal position extending out from tail 5, i.e., with support filament 22 and hook shank 23 being approximately parallel to the longitudinal axis 21 of lure 20, as shown in FIG. 2. Because support filament 22 is also flexible, hook 8 can respond to forces produced during pulling or cranking lure 20 through the water by wriggling in a side-to-side like manner closely resembling the natural tail fin motion of a fish. As long as the lure 20 is horizontal, tail hook 8 will be approximately horizontal. This horizontal orientation of the tail hook 8, dressed to simulate a fish tail fin, is substantially more realistic in appearance, performance, and function compared to the prior art. When using a stop-and-go presentation, the tail hook 8 does not drop down, but remains approximately horizontal, thus, substantially increasing the catch-to-strike ratio over the prior art. This is due not only to the semi-rigid and flexible nature of the support filament 22, but also to the fact that the support filament 22 is not visible when a clear plastic monofilament is used. The flexibility also allows the tail hook 8 to move while the angler is fighting a fish, enhancing the chance that the fish will not be able to throw the hook.

In the prior art lure shown in FIG. 1, the hook 8 can easily become entangled with weeds on the bottom of a body of water. The hook 8 of the present invention is relatively weedless because it remains approximately horizontally projected when the lure is resting on the bottom or remaining motionless.

The foregoing description has been limited to specific embodiments of this invention. It will be apparent, however, that variations and modifications may be made by those skilled in the art to the disclosed embodiments of the invention, with the attainment of some or all of its advantages and without departing from the spirit and scope of the present invention. For example, the support filament 22 may be connected to tail 5, or any other suitable area of the lure body, by gluing it directly, or it may be stapled, clamped, or fastened with a screw, tack, or nail. Support filament 22 may be attached to hook shank 23, or to any other suitable part of hook 8, with glue, wire, thread, string, or a clamp. Support filament 22 may be composed of metal or fiber and can be multi filament. The main body of lure 20, including nose 4 and tail 5, can be constructed by methods and materials well known in the art of fish lures. Hook 8 may have one or more hook tips.

It will be understood that various changes in the details, materials, and arrangements of the parts which have been described and illustrated above in order to explain the nature of this invention may be made by those skilled in the art without departing from the principle and scope of the invention as recited in the following claims.

I claim:

1. A fish lure, comprising:
a) a body having a head end and a tail end defining a longitudinal axis;
b) said tail end having a hook with one or more hook tips, said hook linked movably to said tail end;
c) a flexible, semi-rigid support filament having a first end and a second end;
d) said first end attached to said tail end and said second end attached to said hook; and
e) said support filament maintaining said hook in an approximately horizontal position approximately parallel to said longitudinal axis.

2. The fish lure of claim 1 wherein said support filament is made of plastic or metal.

3. The fish lure of claim 2 wherein said support filament is plastic fishing line ranging from 12 lb. to 25 lb. test.

4. The fish lure of claim 3 wherein said support filament is clear plastic.

5. The fish lure of claim 1 wherein said hook is a treble hook.

6. The fish lure of claim 5 wherein said hook is dressed.

7. The fish lure of claim 1 wherein said first end of said support filament is removably attached to said tail end.

8. The fish lure of claim 1 wherein said first end of said support filament is permanently attached to said tail end.

9. The fish lure of claim 1 wherein said second end of said support filament is removably attached to said hook with a rubber band.

10. The fish lure of claim 1 wherein said second end of said support filament is permanently attached to said hook.

11. The fish lure of claim 1 wherein said hook has a shank, and said second end of said support filament is attached to said shank.

12. A fish lure, comprising:
a) a body having a head end and a tail end defining a longitudinal axis;
b) said tail end having a dressed hook with one or more hook tips, said hook linked movably to said tail end;
c) said hook having a shank;
d) a flexible, semi-rigid clear plastic support filament having a first end and a second end;
e) said first end permanently attached to said tail end and said second end removably attached to said shank; and
f) said support filament maintaining said shank of said hook in an approximately horizontal position approximately parallel to said longitudinal axis.
